(19) United States
(12) Patent Application Publication
(10) Pub. No.: US 2018/0227674 A1
(43) Pub. Date: Aug. 9, 2018

(54) AN ELECTROSTATIC LOUDSPEAKER AND METHOD OF SAME

(71) Applicant: WIZEDSP LTD., TEL-AVIV (IL)

(72) Inventor: OZ GABAI, TEL-AVIV (IL)

(73) Assignee: WIZEDSP LTD., TEL-AVIV (IL)

(21) Appl. No.: 15/579,954

(22) PCT Filed: Jun. 7, 2016
(86) PCT No.: PCT/IB2016/053319

§ 371 Date: Dec. 15, 2016

Related U.S. Application Data
(60) Provisional application No. 62/172,581, filed on Jun. 8, 2015.

(51) Int. Cl. H04R 19/02; H04R 3/06; H04R 31/00

(52) U.S. Cl. CPC H04R 19/02; H04R 7/04; H04R 31/00; H04R 3/06

(57) ABSTRACT

An electrostatic loudspeaker, or a diaphragm for an electrostatic loudspeaker, where the diaphragm includes a plurality of conductive parts and, at least one insulator part separating between the conductive parts, and where each of the plurality of conductive parts is electrically connectable to a different bias voltage according to the minimal distance between the particular conductive part and one or more fixed conductive grids positioned in parallel to the diaphragm.

### CROSS-REFERENCE TO RELATED APPLICATIONS

This application claims the benefit of U.S. Provisional Application No. 62/172,581, filed Jun. 8, 2015, the disclosure of which is incorporated herein by reference in its entirety.

### FIELD

The method and apparatus disclosed herein are related to the field of acoustic transducers, and, more particularly but not exclusively, to capacitance-based loudspeakers, or electrostatic loudspeakers.

### BACKGROUND

Loudspeakers are important components in our lives, being used in cellphones, earpieces, earring aids, etc. Most of the loudspeakers used are electromagnetic loudspeakers, which suffer bad response and low efficiency. Electromagnetic loudspeakers have extremely low efficiency in converting electric energy to acoustic pressure wave energy.

More devices are being connected to the Internet, such as sensors, watches, toys, air conditions, electronic light switches, light bulbs and more. This trend is called Internet of Things (IoT) or Internet of Everything (IoE). It is anticipated that by 2020 over 50 billion devices will be connected to the Internet. Many of these devices would be powered by batteries or harvested energy, requiring high energy efficiency

Alternative connectivity to the Internet may use acoustic waves in the range of 14,000 Hz-20,000 Hz. This frequency range is already supported by most smart devices, such as cellphones and tablets. Acoustic communication may use very low bandwidth and hence, according to the power consumption formula, consume less energy than electromagnetic communication technologies such as Bluetooth. To benefit from the low bandwidth required by the acoustic communication system efficient loudspeakers are required. According to “Electrostatic Graphene Loudspeaker” by Qin Zhou & A. Zettl (published in Applied Physics Letters, 102, 223109 (2013)) it is possible to construct an Electrostatic loudspeaker with a power efficiency close to 1.

There is thus a widely recognized need for, and it would be highly advantageous to have, a loudspeaker that overcomes the above limitations.

### SUMMARY

According to one exemplary embodiment, there is provided a capacitive loudspeaker, and/or an electrostatic loudspeaker, and/or a diaphragm for a capacitive loudspeaker and/or electrostatic loudspeaker, and/or a method therefore, where the diaphragm of the electrostatic loudspeaker includes a plurality of conductive parts and, at least one insulator part separating between the conductive parts, and where each of the plurality of conductive parts is electrically connectable to a different voltage.

According to another exemplary embodiment the conductive parts are at least one of circular, radial, round, ring-shape, quadrangle, square, and trapezoid.

According to yet another exemplary embodiment the loudspeaker also includes a first conductive grid located on a first side of the diaphragm, and a second conductive grid located on a second side of the diaphragm.

According to still another exemplary embodiment at least one dimension of at least one conductive part of the plurality of conductive parts is determined according to distance between the conductive part and at least one of the conductive grids.

Further according to another exemplary embodiment each of the plurality of conductive parts is electrically connectable to a different bias voltage, and the bias voltage is determined according to distance between the conductive part and at least one of the conductive grids.

Further according to another exemplary embodiment an electronic circuit may include a first bias resistor providing maximal voltage to a first conductive part of said diaphragm, and a pair of bias resistors for each other conductive part of said diaphragm, electrically coupled as a voltage divider to provide suitable voltage to each of the other conductive parts.

Further according to another exemplary embodiment an electronic circuit includes a set of N resistors electrically coupled in series as a voltage divider ladder, where N is the number of conductive parts of said diaphragm, where a first terminal of a first resistor is connected to a charge pump output and to a first conductive part of the plurality of conductive parts, where a second terminal of the first resistor is connected to a second resistor and to a second conductive part of the plurality of conductive parts, and where the resistor circuitry is repeated for all N resistors.

Further according to another exemplary embodiment an electronic circuit includes a set of N charge pumps, where N is the number of conductive parts of said diaphragm, where each of the charge pumps is connected to a different conductive part.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1A and FIG. 1B are simplified illustrations of two exemplary types of electrostatic loudspeakers;

FIG. 1C and FIG. 1D are simplified illustrations of two operational states of an electrostatic loudspeaker;

FIG. 2 is a simplified illustration of a side view of an electrostatic loudspeaker with an electric schematic of a driving circuit;

FIG. 3 is a simplified illustration of a top view of a diaphragm of an electrostatic loudspeaker;

FIG. 4 is a simplified illustration of a side view of an electrostatic loudspeaker with the diaphragm of FIG. 3;

FIG. 5 is a simplified illustration of an implementation of the electrostatic loudspeaker of FIGS. 3 and 4 with an electrical schematic diagram of a driving circuit;

FIG. 6 is a simplified illustration of the electrostatic loudspeaker of FIG. 5 with an electrical schematic diagram of a driving circuit using a single charge pump; and

FIG. 7 is a simplified illustration of the electrostatic loudspeaker of FIG. 5 or 6 with an electrical schematic diagram of a driving circuit using a single charge pump and a voltage ladder divider.

### DETAILED DESCRIPTION

The invention in embodiments thereof comprises systems and methods for capacitance-based loudspeakers, and, more particularly, but not exclusively to diaphragm structure and/or biasing for electrostatic loudspeakers. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of embodiments described below is to provide at least one system and/or method for a high-power, high-efficiency electrostatic loudspeaker. However, the systems and/or methods as described herein may have other embodiments in similar technologies of capacitor-based loudspeakers.

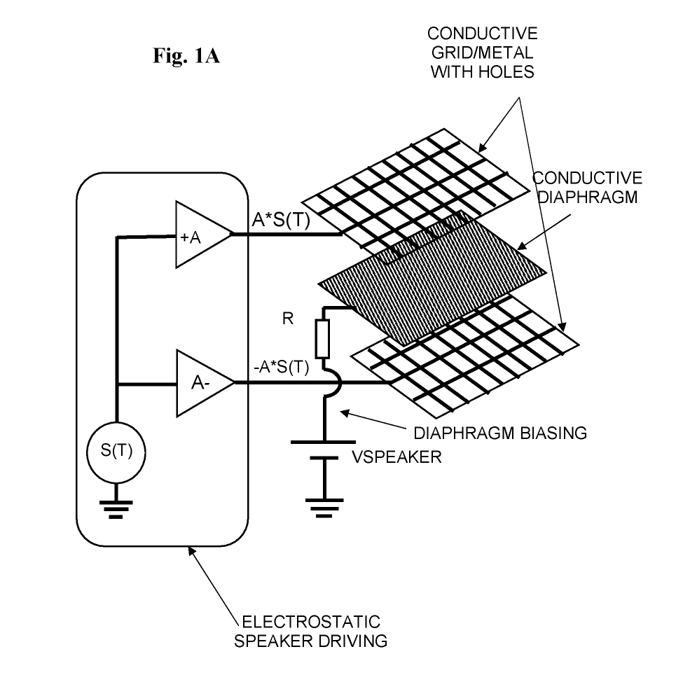

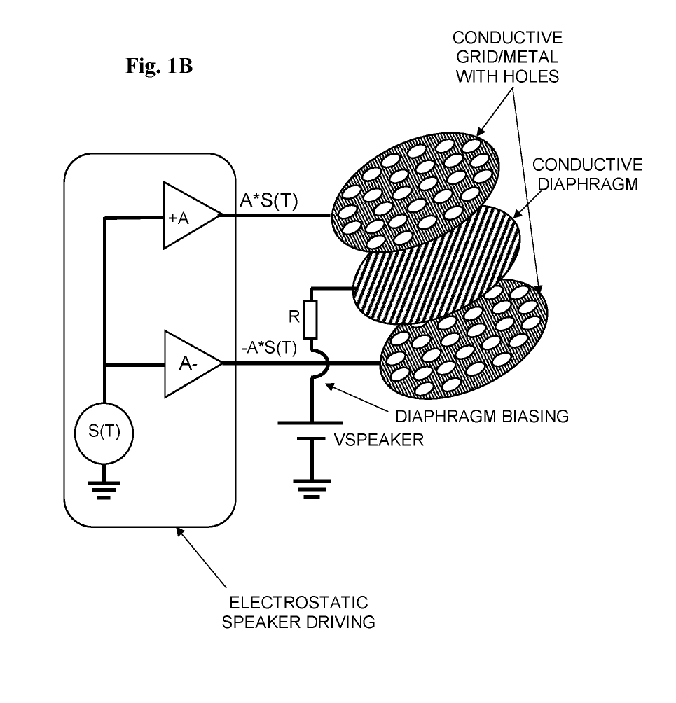

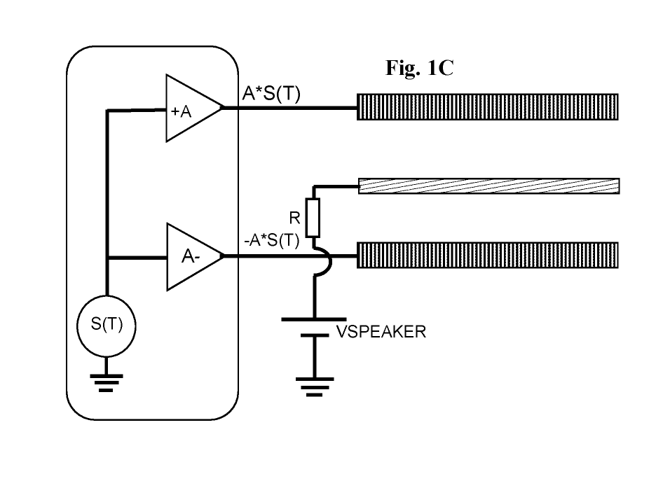

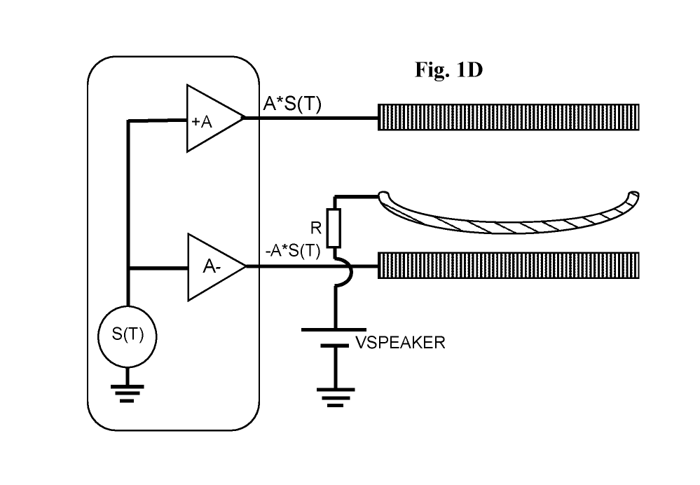

Reference is now made to FIG. 1A and FIG. 1B, which are simplified illustrations of two exemplary types of electrostatic loudspeakers, and to FIG. 1C and FIG. 1D, which are simplified illustrations of two operational states of an electrostatic loudspeaker, according to one exemplary embodiment.

FIG. 1A shows an electrostatic loudspeaker having a bias circuit, a signal driving circuit, and a square-shaped diaphragm, while FIG. 1B shows an electrostatic loudspeaker having a bias circuit, a signal driving circuit, and a round diaphragm. FIG. 1C shows a side view of the electrostatic loudspeaker with a bias circuit and a signal driving when the diaphragm is in rest position. FIG. 1D shows a side view of the electrostatic loudspeaker with a bias circuit and a signal driving circuit with the diaphragm moved down by the electrostatic force. FIG. 1C and/or FIG. 1D may refer to any of the electrostatic loudspeakers as shown in FIG. 1A and/or FIG. 1B.

As shown in FIG. 1A and/or FIG. 1B an electrostatic loudspeaker may have at least one conductive grid or conductive metal layers with holes and an elastic and conductive diaphragm. Typically, the diaphragm may be placed between the two conductive grids as shown in FIG. 1A and FIG. 1B. The diaphragm may be held fixed by its edges. Placing a high positive voltage on the diaphragm will cause the injection of constant charge Q on the diaphragm. This charge is then transferred via a high resistor, such that the charge Q on the diaphragm may not change during normal operation.

Placing a signal on one or more of the conductive grids may create an electric field between the two conductive grids, which creates a force that may pull the diaphragm up or down, as shown in FIG. 1D. If the diaphragm is held fixed at the edges, the diaphragm, when pulled to either sides, may have a parabola shape. Pulling the diaphragm up or down may create an acoustic pressure waves, which may pass through the conductive grid. The terms ‘up’ and/or ‘down’ and/or ‘upper’ or ‘lower’ refer to the position of the elements as shown in any of FIGS. 1A, 1B, 1C, and 1D.

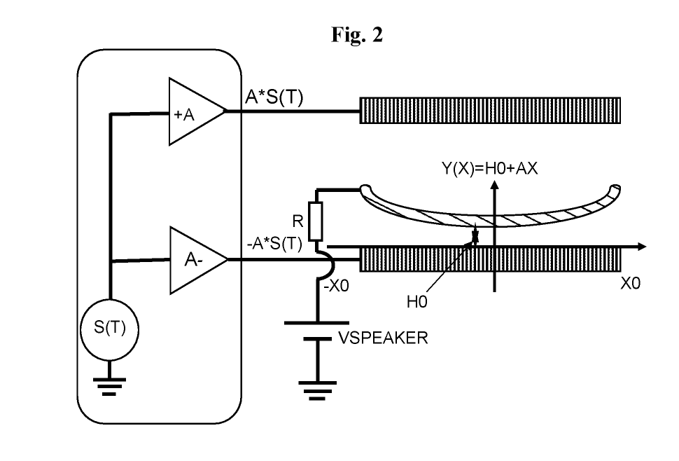

Reference is now made to FIG. 2, which is a simplified illustration of a side view of an electrostatic loudspeaker with an electric schematic of a driving circuit, according to one exemplary embodiment.

As an option, the illustration and/or the electric schematic of FIG. 2 may be viewed in the context of the details of the previous Figures. Of course, however, illustration and/or the electric schematic of FIG. 2 may be viewed in the context of any desired environment. Further, the aforementioned definitions may equally apply to the description below.

As shown in FIG. 2, Vspeaker is the bias voltage to the diaphragm. Vspeaker is limited by the voltage breakdown in air. The voltage breakdown in air is 3,000,000 Volt/meter, and therefore, for a minimal distance h0 between the diaphragm and a conductive grid, Vspeaker is limited so that the maximal absolute value of A*S(t)=A*Smax, where S(t) is the signal driving the electrostatic speaker and Smax is the maximum value of |S(t)|.

In other words, A*Smax+Vspeaker<3000,000*h0 or

Vₛₚₑₐₖₑᵣ<3000000h₀−ASₘₐₓ Eq. 1

Assuming that h0=50 μm then Vspeaker is limited by 150−ASmax, and for ASmax=10V, Vspeaker is limited to 140V.

It may be possible to get a stronger acoustic pressure signal by applying different bias voltages to different parts of the diaphragm according to the minimum distance between the particular part of the diaphragm and the respective conductive grid.

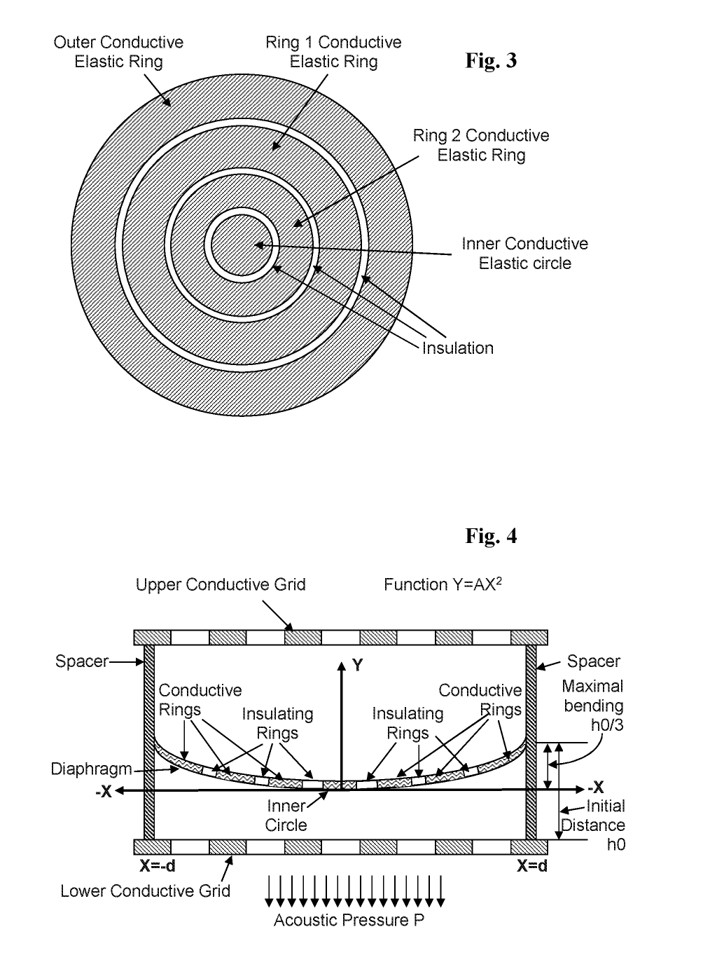

Reference is now made to FIG. 3, which is a simplified illustration of a top view of a diaphragm of an electrostatic loudspeaker, according to one exemplary embodiment.

As an option, the diaphragm of FIG. 3 may be viewed in the context of the details of the previous Figures. Of course, however, the diaphragm of FIG. 4 may be viewed in the context of any desired environment. Further, the aforementioned definitions may equally apply to the description below.

As shown in FIG. 3, the diaphragm may include a plurality of regions, or conductive areas, separated by insulating material. For example, the diaphragm of FIG. 4 includes four regions in the form of a conductive round and three conductive rings, with three separating insulating rings between. It is appreciated that the diaphragm may have a different shape, and may be divided into any number of regions of various shapes.

Reference is now made to FIG. 4, which is a simplified illustration of a side view of an electrostatic loudspeaker with the diaphragm of FIG. 3, according to one exemplary embodiment.

As an option, the electrostatic loudspeaker of FIG. 4 may be viewed in the context of the details of the previous Figures. Of course, however, the electrostatic loudspeaker of FIG. 4 may be viewed in the context of any desired environment. Further, the aforementioned definitions may equally apply to the description below.

As shown in FIG. 4, the diaphragm bending is a function of the electrical field, and the Vspeaker. A round electrostatic loudspeaker may have circular regions, however different mechanical structures may have different shapes of conductive regions.

Assume that the shape of the bending is given by Eq. 2:

y=Ax² Eq. 2

for a third of the initial distance h0, we get

$$A = \frac{{h}_{0}}{3 {d}^{2}} , or y = ( \frac{{h}_{0}}{3 {d}^{2}} ) {x}^{2} \qquad Eq . 3$$

We can now show that the total Q on the diaphragm in this case is:

$$Q = {\int }_{x = 0}^{d} {ɛ}_{0} \frac{2 π xdx}{{h}_{0}} B ( ( \frac{{h}_{0}}{3 {d}^{2}} ) {x}^{2} + \frac{2 {h}_{0}}{3} ) = {\int }_{x = 0}^{d} {ɛ}_{0} \frac{2 π xdx}{{h}_{0}} B \frac{2 {h}_{0}}{3} + {\int }_{x = 0}^{d} {ɛ}_{0} \frac{2 π xdx}{{h}_{0}} B ( ( \frac{{h}_{0}}{3 {d}^{2}} ) {x}^{2} ) , \qquad Eq . 4$$

where the term

$${\int }_{x = 0}^{d} {ɛ}_{0} \frac{2 π xdx}{{h}_{0}} B \frac{2 {h}_{0}}{3}$$

represents the Q of a normal electrostatic loudspeaker implementation, and the term

$${\int }_{x = 0}^{d} {ɛ}_{0} \frac{2 π xdx}{{h}_{0}}$$

represents the capacitance of a radial-plates electrostatic loudspeaker capacitor which is measured from the diaphragm to the conductive grid, when there is no input signal presented at the driving circuit. B=3 Mega Volts/meter is the air breakdown voltage. The term

$${\int }_{x = 0}^{d} {ɛ}_{0} \frac{2 π xdx}{{h}_{0}} B ( ( \frac{{h}_{0}}{3 {d}^{2}} ) {x}^{2} )$$

represents the increase of Q due to the use of the diaphragm as shown and described with reference to FIG. 3 and FIG. 4.

Therefore, according to Eq. 5:

$${\int }_{x = 0}^{d} {ɛ}_{0} \frac{2 π xdx}{{h}_{0}} B ( ( \frac{{h}_{0}}{3 {d}^{2}} ) {x}^{2} ) = {ɛ}_{0} \frac{2 π}{{h}_{0}} \frac{{h}_{0}}{3 {d}^{2}} B \frac{{d}^{4}}{4} = ( B \frac{2 {h}_{0}}{3} ) ( {ɛ}_{0} \frac{π {d}^{2}}{{h}_{0}} ) ( \frac{1}{4} ) \qquad Eq . 5$$

the theoretical increase of Q is by 1.25.

According to page 110, Eq. 3.2 of “Loudspeaker and headphone handbook” by John Borwick (printed by Focal Press, an imprint of Butterworth-Heinemann, Linacre House, Jordan Hill, Oxford OX2 8DP, 225 Wildwood Avenue, Woburn, Mass. 01801-2041, A division of Reed Educational and Professional Publishing Ltd), the force that appears on the diaphragm is described by Eq. 6:

$${F}_{sig} = Q \frac{{V}_{sig}}{d} = Q \frac{( AS ( t ) )}{{h}_{0}} , where Q \frac{( AS ( t ) )}{{h}_{0}} \qquad Eq . 6$$

is the force using the notation and marking of FIG. 1A-1D. Therefore, the electrostatic loudspeaker of FIGS. 3 and 4 may provide about 2 dB increase in the force, or in the acoustic pressure, as given by Eq. 7:

20 log₁₀(1.25)=1.9382 dB Eq. 7

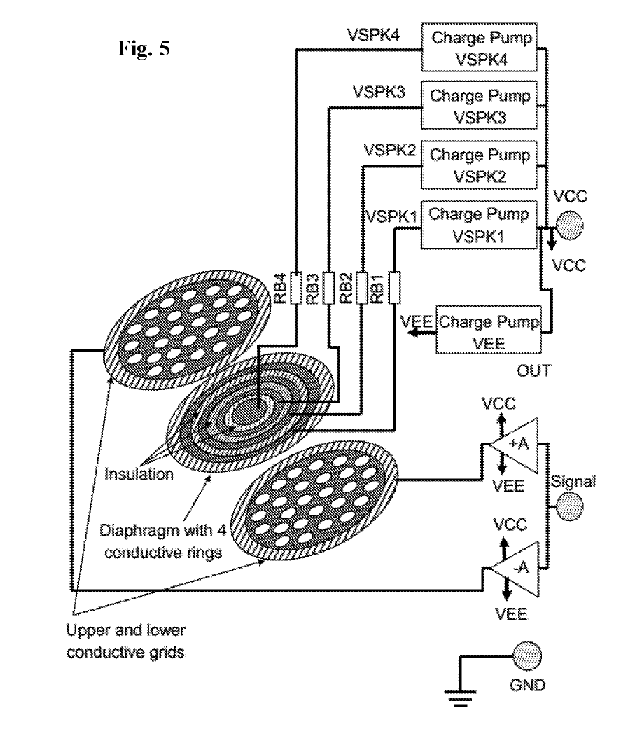

Reference is now made to FIG. 5, which is a simplified illustration of an implementation of the electrostatic loudspeaker of FIGS. 3 and 4 with an electrical schematic diagram of a driving circuit, according to one exemplary embodiment.

As an option, the illustration and electrical schematic of FIG. 5 may be viewed in the context of the details of the previous Figures. Of course, however, the illustration and electrical schematic of FIG. 5 may be viewed in the context of any desired environment. Further, the aforementioned definitions may equally apply to the description below.

As shown in FIG. 5, each conductive ring (four rings are shown in this example), may receive a different Vspeaker voltage. The electric signals +AS(t) and −AS(t) may generate a force that may move the diaphragm up or down.

Each ring may receive a nearly maximum voltage according to Eq. 1, accounting for the distance of the ring from the upper and lower conductive rings.

To generate the different Vspeaker voltages, the implementation as shown by FIG. 4 may use DC to DC charge pumps (charge pumps have high efficiency and are simple to implement on a chip). Another DC-to-DC charge pump is added to generate a negative voltage VEE, which is needed for the signal driving amplifier. The signal driving amplifier, may work around Vdc=0, and may generate positive and negative voltages. Therefore, a negative VEE and a positive VCC voltages are required as supply voltages to the driving amplifiers +A and −A.

The driving amplifiers are connected directly to the upper and lower conductive grids, as shown and described with reference to FIGS. 1A-1D.

Using bias resistors RB of high resistance, the diaphragm rings may consume very little power. It is then possible to use only one charge pump (instead of four), which may be designed according to the highest required voltage, and then to use resistors as voltage dividers for the required lower voltages.

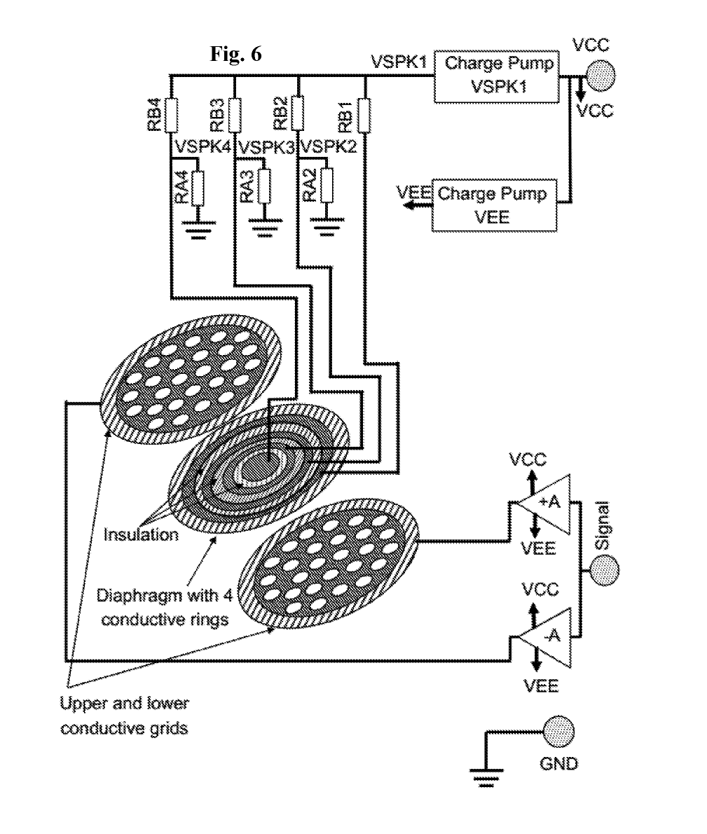

Reference is now made to FIG. 6, which is a simplified illustration of the electrostatic loudspeaker of FIG. 5 with an electrical schematic diagram of a driving circuit using a single charge pump, according to one exemplary embodiment.

As an option, the electrostatic loudspeaker and the driving circuit of FIG. 6 may be viewed in the context of the details of the previous Figures. Of course, however, the electrostatic loudspeaker and the driving circuit of FIG. 6 may be viewed in the context of any desired environment. Further, the aforementioned definitions may equally apply to the description below.

As shown in FIG. 6, a single DC-to-DC charge pump may be used to generate the lower voltages Vspk4<Vspk3<Vspk2<Vspk1. The higher voltage Vspk1 may be applied to the external conductive ring of the diaphragm. Resistor voltage dividers pairs, RB2 & RA2 may generate Vspk2, such that Vspk1*RA2/(RA2+RB2)=Vspk2. Vspk2 may then be applied to the first (inner) conductive elastic ring (as defined in FIG. 3). Similarly, resistors RB3 and RA3 may generate Vspk3, such that Vspk1*RA3/(RA3+RB3)=Vspk3. Vspk3 may then be applied to the second (inner) conductive elastic ring (as defined in FIG. 3). Eventually, resistors RB4 and RA4 may generate Vspk4, such that Vspk1*RA4/(RA4+RB4)=Vspk4. Vspk4 may then be applied to the inner conductive elastic circle (as defined in FIG. 3).

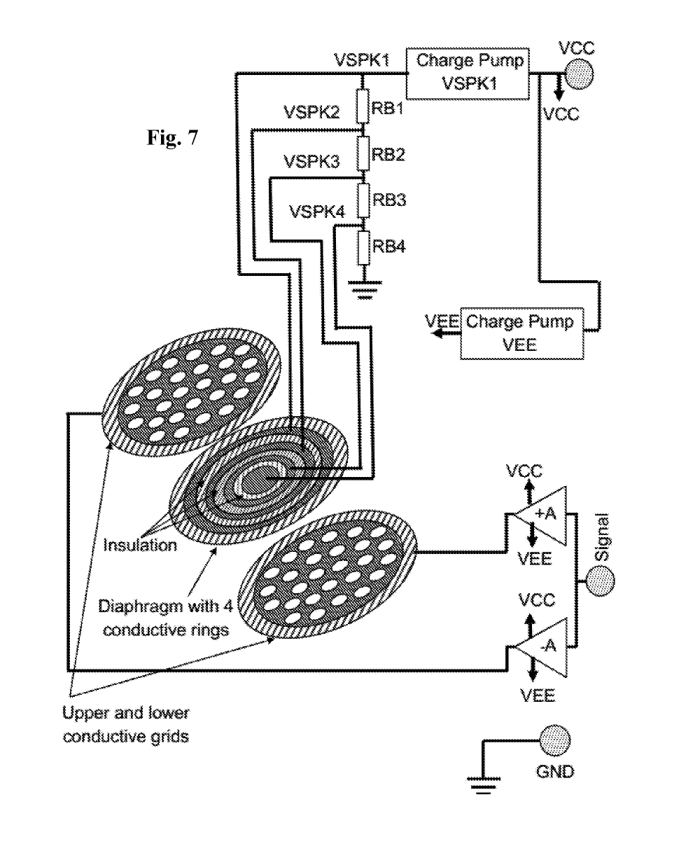

Reference is now made to FIG. 7, which is a simplified illustration of the electrostatic loudspeaker of FIG. 5 or 6 with an electrical schematic diagram of a driving circuit using a single charge pump and a voltage ladder divider, according to one exemplary embodiment.

As an option, the electrostatic loudspeaker and the driving circuit of FIG. 7 may be viewed in the context of the details of the previous Figures. Of course, however, the electrostatic loudspeaker and the driving circuit of FIG. 7 may be viewed in the context of any desired environment. Further, the aforementioned definitions may equally apply to the description below.

As shown in FIG. 7, to generate Vspk4<Vspk3<Vspk2<Vspk1 from Vspk1, a ladder divider may be used. The ladder divider may include four resistors RB1, RB2 RB3 and RB4 such that:

Vspk2=Vspk1*(RB2+RB3+RB4)/(RB1+RB2+RB3+RB4),

Vspk3=Vspk1*(RB3+RB4)/(RB1+RB2+RB3+RB4), and

Vspk4=Vspk1*(RB4)/(RB1+RB2+RB3+RB4).

The resistors RB1, RB2 RB3 and RB4 may be in the range of 100 MOhm-500 MOhm. In such case the current consumption of the resistor network may not be a concern even when using a 150V Vspk1.

FIGS. 5, 6 and 7 describe three methods for generating the bias voltages required for the conductive areas of the diaphragm of the electrostatic loudspeaker. It is appreciated that others ways of generating these bias voltages may be used, such as using switching regulators.

It is appreciated that although FIGS. 3, 4, 5, 6 and 7 discuss a round electrostatic loudspeaker and/or a round diaphragm, others loudspeaker shapes and/or diaphragm shapes may be used. For example, a square-shaped loudspeaker and/or diaphragm, and a multi-line loudspeaker and/or diaphragm.

It is appreciated that although the conductive areas in this description are defined according to the height regions, it is understood that conductive areas and/or region may user other criteria. The term ‘height” may refer to the distance between the region and at least one of the conductive grids. Particularly the term ‘height” may refer to the minimum distance between the region and at least one of the conductive grids. The term ‘equal height” may refer to a representative distance between the region and at least one of the conductive grids. Such distance may be the smallest distance between the region and at least one of the conductive grids.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A diaphragm for an electrostatic loudspeaker comprising:
a plurality of conductive parts; and
at least one insulator part separating between said conductive parts;
wherein each of said plurality of conductive parts is electrically connectable to a different voltage.

2. The diaphragm of claim 1, wherein said conductive parts are at least one of circular, radial, round, ring-shape, quadrangle, square, and trapezoid.

3. The diaphragm of claim 1, additionally comprising:
a first conductive grid located on a first side of said diaphragm; and
a second conductive grid located on a second side of said diaphragm.

4. The diaphragm of claim 3, wherein at least one dimension of at least one conductive part of said plurality of conductive parts is determined according to distance between said conductive part and at least one of said conductive grids.

5. The diaphragm of claim 3, wherein each of said plurality of conductive parts is electrically connectable to a different bias voltage, and wherein said bias voltage is determined according to distance between said conductive part and at least one of said conductive grids.

6. The diaphragm of claim 1, additionally comprising:
a first bias resistor providing maximal voltage to a first conductive part; and
a pair of bias resistors for each other conductive part, electrically coupled as a voltage divider to provide suitable voltage to each of said other conductive parts.

7. The diaphragm of claim 1, additionally comprising:
a set of N resistors electrically coupled in series as a voltage divider ladder, wherein N is the number of conductive parts;
wherein a first terminal of a first resistor is electrically coupled to a charge pump output and to a first conductive part of said plurality of conductive parts;
wherein a second terminal of said first resistor is electrically coupled to a second resistor and to a second conductive part of said plurality of conductive parts; and
wherein electrical coupling according to said first resistor and first conductive part is repeated for all other resistors of said voltage divider ladder and respective conductive parts.

8. The diaphragm of claim 1, additionally comprising:
a set of N charge pumps, wherein N is the number of conductive parts;
wherein each of said charge pumps is connected to a different conductive part.

9. A method for producing acoustic signal using an electrostatic loudspeaker, the method comprising:
providing a diaphragm of said electrostatic loudspeaker, said diaphragm comprising: a plurality of conductive parts and at least one insulator part separating between said conductive parts; and
providing a different bias voltage to each of said plurality of conductive parts.

10. The method according to claim 9, wherein said conductive parts are provided as at least one of circular, radial, round, ring-shape, quadrangle, square, and trapezoid.

11. The method according to claim 9, additionally comprising:
providing a first conductive grid located on a first side of said diaphragm; and
providing a second conductive grid located on a second side of said diaphragm.

12. The method according to claim 11, additionally comprising:
adapting at least one dimension of at least one conductive part of said plurality of conductive parts is determined to distance between said conductive part and at least one of said conductive grids.

13. The method according to claim 11, additionally comprising:
connecting each of said plurality of conductive parts to a different bias voltage; and
adapting said bias voltage is determined according to distance between said conductive part and at least one of said conductive grids.

14. The method according to claim 9, additionally comprising:
providing a first bias resistor providing maximal voltage to a first conductive part; and
providing a pair of bias resistors for each other conductive part, electrically coupled as a voltage divider to provide suitable voltage to each of said other conductive areas.

15. The method according to claim 9, additionally comprising:
providing a set of N resistors electrically coupled in series as a voltage divider ladder, wherein N is the number of conductive parts;
connecting a first terminal of a first resistor to a charge pump output and to a first conductive part of said plurality of conductive parts;
connecting a second terminal of said first resistor to a second resistor and to a second conductive part of said plurality of conductive parts; and
repeating electrical coupling according to said first resistor and first conductive part for all other resistors of said voltage divider ladder and respective conductive parts.

16. The method according to claim 9, additionally comprising:
providing a set of N charge pumps, wherein N is the number of conductive parts; and
connecting each of said charge pumps to a different conductive part.
